(19) United States
(12) Patent Application Publication
(10) Pub. No.: US 2009/0002156 A1
(43) Pub. Date: Jan. 1, 2009

(54) Method and apparatus for correlating non-critical alarms with potential service disrupting events

(76) Inventors: Marian Croak, Fair Haven, NJ (US); Hossein Eslambolchi, Los Altos Hills, CA (US)

Correspondence Address: Mr. S.H. Dworetsky;AT&T Corp., Room 2A-207; One AT&T Way, Bedminster, NJ, 07921, US

(21) Appl. No.: 11/023,788

(22) Filed: Dec. 28, 2004

(51) Int. Cl. G08B 21/00

(52) U.S. Cl. 340/540

(57) ABSTRACT

The present invention enables the correlation of low-level alarms across a specified period of time to determine if the aggregation of such alarms is a harbinger of an impending customer impacting service disruption. The low level alarms can be mapped against historical trends of other conditions that preceded other service disruptions as a predictor of the likelihood of an impending re-occurrence of such an event.

The present invention relates generally to communication networks and, more particularly, to a method and apparatus for correlating non-critical or low level alarms with potential service disrupting events in packet-switched networks, e.g., Voice over Internet Protocol (VoIP) networks.

### BACKGROUND OF THE INVENTION

Increasingly, VoIP network services are being designed to meet the same level of reliability as the Public Switched Telephone Network (PSTN). Events in the VoIP network are monitored, and traps and alarms are generated when errors occur. Occasionally, seemingly minor errors occur throughout an operations period that is quickly dismissed as non-critical because they do not exceed a certain threshold or in isolation appear to be innocuous. These errors produce alarms that are automatically cleared without creating a notification that would bring them to the attention of a human operator. On rare occasions, in aggregate, these seemingly minor errors may be a forewarning of potential problems.

Therefore, a need exists for a method and apparatus for correlating non-critical alarms with potential service disrupting events in packet-switched networks, e.g., Voice over Internet Protocol (VoIP) networks.

### SUMMARY OF THE INVENTION

In one embodiment, the present invention enables the correlation of non-critical or low-level alarms across a specified period of time to determine if the aggregation of such alarms is a harbinger of an impending customer impacting service disruption. The low level alarms can be mapped against historical trends of other conditions that preceded other service disruptions as a predictor of the likelihood of an impending re-occurrence of such an event.

### BRIEF DESCRIPTION OF THE DRAWINGS

The teaching of the present invention can be readily understood by considering the following detailed description in conjunction with the accompanying drawings, in which:

FIG. 1 illustrates an exemplary Voice over Internet Protocol (VoIP) network related to the present invention;

FIG. 2 illustrates an example of collecting alarm status within a VoIP network of the present invention;

FIG. 3 illustrates a flowchart of a method for collecting alarm status within a VoIP network of the present invention;

FIG. 4 illustrates a flowchart of a method for correlating non-critical alarms with potential service disrupting events in a VoIP network of the present invention; and

FIG. 5 illustrates a high level block diagram of a general purpose computer suitable for use in performing the functions described herein.

To facilitate understanding, identical reference numerals have been used, where possible, to designate identical elements that are common to the figures.

### DETAILED DESCRIPTION

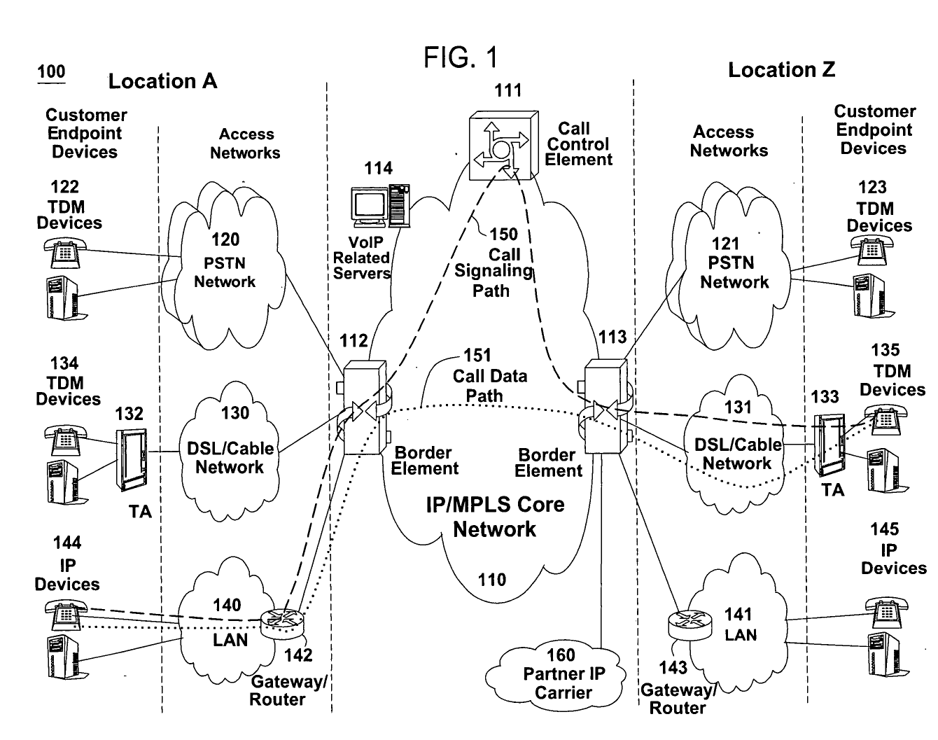

To better understand the present invention, FIG. 1 illustrates an example network, e.g., a packet-switched network such as a VoIP network related to the present invention. The VoIP network may comprise various types of customer endpoint devices connected via various types of access networks to a carrier (a service provider) VoIP core infrastructure over an Internet Protocol/Multi-Protocol Label Switching (IP/MPLS) based core backbone network. Broadly defined, a VoIP network is a network that is capable of carrying voice signals as packetized data over an IP network. An IP network is broadly defined as a network that uses Internet Protocol to exchange data packets.

The customer endpoint devices can be either Time Division Multiplexing (TDM) based or IP based. TDM based customer endpoint devices 122, 123, 134, and 135 typically comprise of TDM phones or Private Branch Exchange (PBX). IP based customer endpoint devices 144 and 145 typically comprise IP phones or PBX. The Terminal Adaptors (TA) 132 and 133 are used to provide necessary interworking functions between TDM customer endpoint devices, such as analog phones, and packet based access network technologies, such as Digital Subscriber Loop (DSL) or Cable broadband access networks. TDM based customer endpoint devices access VoIP services by using either a Public Switched Telephone Network (PSTN) 120, 121 or a broadband access network via a TA 132 or 133. IP based customer endpoint devices access VoIP services by using a Local Area Network (LAN) 140 and 141 with a VoIP gateway or router 142 and 143, respectively.

The access networks can be either TDM or packet based. A TDM PSTN 120 or 121 is used to support TDM customer endpoint devices connected via traditional phone lines. A packet based access network, such as Frame Relay, ATM, Ethernet or IP, is used to support IP based customer endpoint devices via a customer LAN, e.g., 140 with a VoIP gateway and router 142. A packet based access network 130 or 131, such as DSL or Cable, when used together with a TA 132 or 133, is used to support TDM based customer endpoint devices.

The core VoIP infrastructure comprises of several key VoIP components, such the Border Element (BE) 112 and 113, the Call Control Element (CCE) 111, and VoIP related servers 114. The BE resides at the edge of the VoIP core infrastructure and interfaces with customers endpoints over various types of access networks. A BE is typically implemented as a Media Gateway and performs signaling, media control, security, and call admission control and related functions. The CCE resides within the VoIP infrastructure and is connected to the BEs using the Session Initiation Protocol (SIP) over the underlying IP/MPLS based core backbone network 110. The CCE is typically implemented as a Media Gateway Controller and performs network wide call control related functions as well as interacts with the appropriate VoIP service related servers when necessary. The CCE functions as a SIP back-to-back user agent and is a signaling endpoint for all call legs between all BEs and the CCE. The CCE may need to interact with various VoIP related servers in order to complete a call that require certain service specific features, e.g. translation of an E.164 voice network address into an IP address.

For calls that originate or terminate in a different carrier, they can be handled through the PSTN 120 and 121 or the Partner IP Carrier 160 interconnections. For originating or terminating TDM calls, they can be handled via existing PSTN interconnections to the other carrier. For originating or terminating VoIP calls, they can be handled via the Partner IP carrier interface 160 to the other carrier.

In order to illustrate how the different components operate to support a VoIP call, the following call scenario is used to illustrate how a VoIP call is setup between two customer endpoints. A customer using IP device 144 at location A places a call to another customer at location Z using TDM device 135. During the call setup, a setup signaling message is sent from IP device 144, through the LAN 140, the VoIP Gateway/Router 142, and the associated packet based access network, to BE 112. BE 112 will then send a setup signaling message, such as a SIP-INVITE message if SIP is used, to CCE 111. CCE 111 looks at the called party information and queries the necessary VoIP service related server 114 to obtain the information to complete this call. If BE 113 needs to be involved in completing the call; CCE 111 sends another call setup message, such as a SIP-INVITE message if SIP is used, to BE 113. Upon receiving the call setup message, BE 113 forwards the call setup message, via broadband network 131, to TA 133. TA 133 then identifies the appropriate TDM device 135 and rings that device. Once the call is accepted at location Z by the called party, a call acknowledgement signaling message, such as a SIP-ACK message if SIP is used, is sent in the reverse direction back to the CCE 111. After the CCE 111 receives the call acknowledgement message, it will then send a call acknowledgement signaling message, such as a SIP-ACK message if SIP is used, toward the calling party. In addition, the CCE 111 also provides the necessary information of the call to both BE 112 and BE 113 so that the call data exchange can proceed directly between BE 112 and BE 113. The call signaling path 150 and the call data path 151 are illustratively shown in FIG. 1. Note that the call signaling path and the call data path are different because once a call has been setup up between two endpoints, the CCE 111 does not need to be in the data path for actual direct data exchange.

Note that a customer in location A using any endpoint device type with its associated access network type can communicate with another customer in location Z using any endpoint device type with its associated network type as well. For instance, a customer at location A using IP customer endpoint device 144 with packet based access network 140 can call another customer at location Z using TDM endpoint device 123 with PSTN access network 121. The BEs 112 and 113 are responsible for the necessary signaling protocol translation, e.g., SS7 to and from SIP, and media format conversion, such as TDM voice format to and from IP based packet voice format.

Increasingly, VoIP network services are being designed to meet the same level of reliability as the Public Switched Telephone Network (PSTN). Events in the VoIP network are monitored, and traps and alarms are generated when errors occur. Occasionally, seemingly minor errors occur throughout an operations period that is quickly dismissed as non-critical because they do not exceed a certain threshold or in isolation appear to be innocuous. These errors produce alarms that are automatically cleared without creating a notification that would bring them to the attention of a human operator. On rare occasions, in aggregate, these seemingly minor errors could be a forewarning of an impending service disruption that may produce serious impacts on customer service.

To address this criticality, the present invention enables the correlation of non-critical or low-level alarms across a specified or predefined period of time (a configurable parameter, e.g., configurable a network provider) to determine if the aggregation of such alarms is a harbinger of an impending customer impacting service disruption. The low level or minor alarms can be mapped against historical trends of other conditions that preceded other service disruptions as a predictor of the likelihood of an impending re-occurrence of such an event.

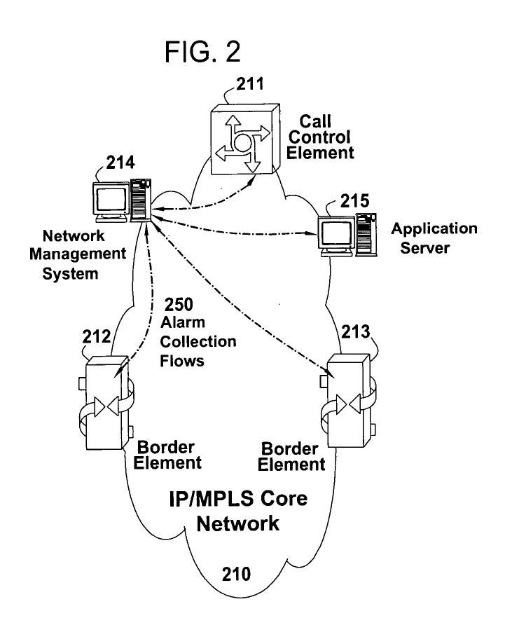

FIG. 2 illustrates an example of collecting alarm status within a packet-switched network, e.g., a VoIP network. In a VoIP network, the Network Management System (NMS) 214 continuously collects alarm indications from all network elements, such as CCE 211, BEs 212, 213, and AS 215. Critical or major alarms are service affecting alarms that require immediate attention from the network provider to restore affected services. Critical or major alarms are usually caused by network element failures within the network. Non-critical, minor, or low level alarms are non-service affecting alarms and don't usually require immediate attention from the network provider. These alarms are usually logged by the NMS and then dismissed or cleared either manually by a network operator or automatically by the NMS. Flow 250 indicates that all alarm types are constantly collected by NMS 214 to diagnose the health of the VoIP network.

The present invention enables minor alarms to be collected by NMS 214 and their occurrences and related information stored based on time-of-date. The NMS then identifies historical trends of alarms immediately preceding previous service impacting network events and uses them as future benchmark to help identify future occurrences of similar service impacting network events. These identified historical trends of alarms include the types of minor alarms and the frequency of their occurrences in a specified period of time. The length of the specified period is a parameter configurable by the network provider. Once these previous historical trends of alarms preceding previous service impacting network events are identified, the data of these historical trends are stored for future use.

The network provider can specify a period of time in which recently collected minor alarms and their historical trends be benchmarked against stored historical trends of minor alarms. If the historical trends of the specified period of time of recently collected minor alarms match that of a previous period of historical trends immediately preceding previous service impacting network events, then an alarm will be raised by the NMS to warn the network provider, a human operator, of the danger of an impending service impacting network event.

It should be noted that non-critical alarms, low level alarms or minor alarms are application specific. Namely, depending on the application and/or the services supported by the network elements, some alarms are critical alarms and some are non-critical alarms. To illustrate, redundancy in network elements and transmission verification of received packets are often practiced by service providers. Network element redundancy often means that there are at two network elements performing the same tasks or supporting the same functions and/or services. As such, there may be non-critical alarms that simply indicate a switching event between redundant network elements. For example, during maintenance, one network element can be taken off-line for repair, upgrade, or replacement, where a redundant network element will come on-line to perform the functions of the network element that has been taken off-line. Alternatively, a possible scenario is where a primary network element has failed and is replaced automatically by a secondary network element. In each of these scenarios, low level alarms can be generated.

For example, timing reference of a network element can be manually or automatically switched to a secondary network element. In another example, a network element may switch from a first power feed to a second power feed due to maintenance being performed on the first power feed. In yet another example, packets are dropped when CRC detects error in IP header and packet of the packets. Discarding a small number of packets is not unusual given that transmission errors do occur regularly, where such transmission errors are typically non-critical. These situations often cause a network to generate a plurality of low level alarms.

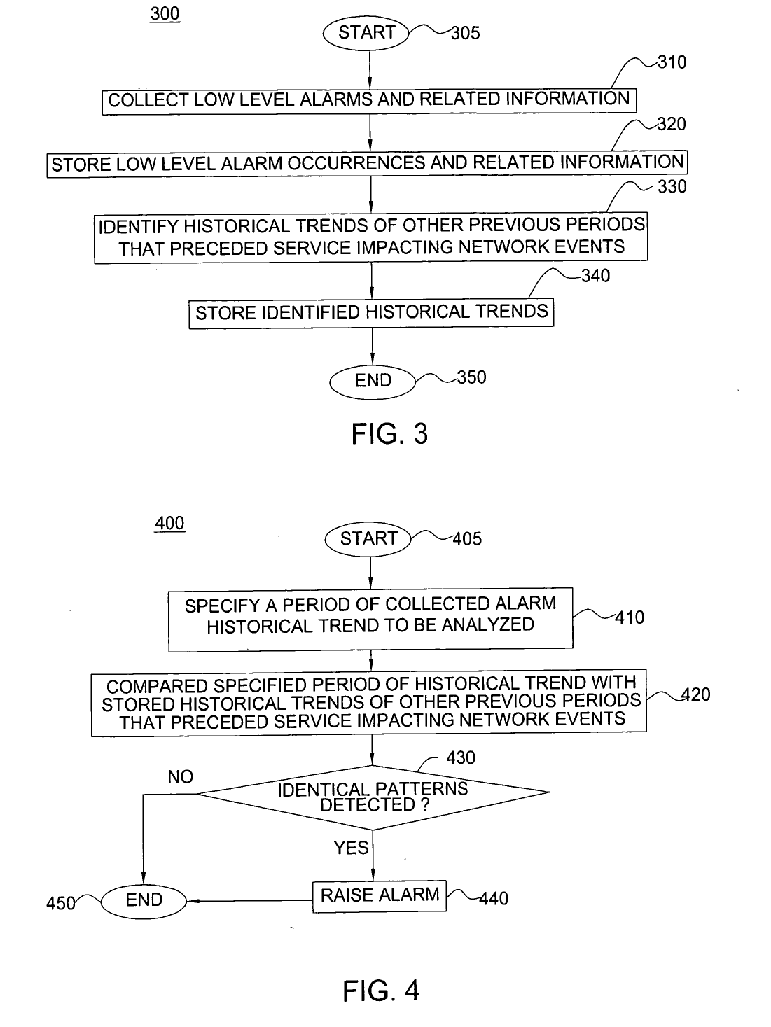

FIG. 3 illustrates a flowchart of a method for collecting alarm status within a packet-switched network, e.g., a VoIP network. Method 300 starts in step 305 and proceeds to step 310.

In step 310, the method collects minor alarm occurrences from all network elements, such as CCE(s), BE(s), AS(s), core routers of the core network and so on. Information collected includes the type of minor alarms and the time-of-date of their occurrences. In step 320, the method stores the collected alarms for further processing. In step 330, the method identifies historical trends of minor alarms of other previous periods that preceded service impacting network events. In step 340, the method stores the identified periods of historical trends as benchmark to help identify future service impacting network events. The method ends in step 350.

FIG. 4 illustrates a flowchart of a method for correlating non-critical alarms with potential service disrupting events in a packet-switched network, e.g., a VoIP network. Method 400 starts in step 405 and proceeds to step 410.

In step 410, the method uses a specified period of recently collected minor alarm historical trends to be analyzed. In step 420, the method compares the specified period of recently collected historical trends with stored historical trends from other previous periods that preceded service impacting network events. In step 430, the method checks if identical patterns between the recently collected minor alarm historical trends and a historical trend from other previous periods that preceded service impacting network events are detected. Historical trend of minor alarm data include the types of minor alarms and the frequency of their occurrences in a specified period of time. If identical patterns are detected, then the method proceeds to step 440; otherwise, the method proceeds to step 450. In step 440, the method raises an alarm to warn the network operator of an impending service impacting network event and human intervention may be immediately required.

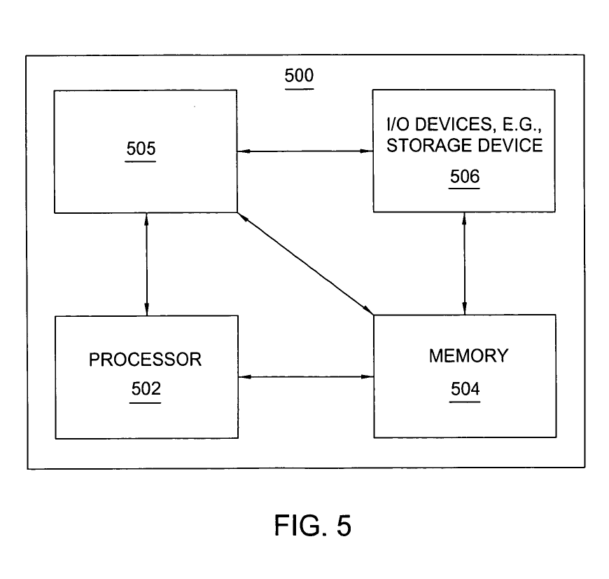

FIG. 5 depicts a high level block diagram of a general purpose computer suitable for use in performing the functions described herein. As depicted in FIG. 5, the system 500 comprises a processor element 502 (e.g., a CPU), a memory 504, e.g., random access memory (RAM) and/or read only memory (ROM), a non-critical alarms correlating module 505, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present non-critical alarms correlating module or process 505 can be loaded into memory 504 and executed by processor 502 to implement the functions as discussed above. As such, the present non-critical alarms correlating process 505 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method for detecting a potential service disrupting event in a communication network, comprising:
collecting a current plurality of minor alarms from at least one network element;
comparing said current plurality of minor alarms with a historical plurality of minor alarms for a predefined period of time; and
raising an alarm if said comparison shows an aberration that is representative of said potential service disrupting event.

2. The method of claim 1, wherein said communication network is a Voice over Internet Protocol (VoIP) network.

3. The method of claim 1, wherein said at least one network element comprises at least one of: a call control element (CCE), a border element (BE), or an application server (AS).

4. The method of claim 1, wherein said comparing is performed by a network management system (NMS).

5. The method of claim 1, wherein said p redefined period of time is determined based on at least one previous service disrupting event.

6. The method of claim 1, wherein a length of said predefined period of time is a configurable parameter.

7. The method of claim 1, wherein said raising comprises:
sending said alarm to a network operator of said communication network if said aberration occurs within said predefined period of time.

8. A computer-readable medium having stored thereon a plurality of instructions, the plurality of instructions including instructions which, when executed by a processor, cause the processor to perform the steps of a method for detecting a potential service disrupting event in a communication network, comprising:
collecting a current plurality of minor alarms from at least one network element;
comparing said current plurality of minor alarms with a historical plurality of minor alarms for a predefined period of time; and
raising an alarm if said comparison shows an aberration that is representative of said potential service disrupting event.

9. The computer-readable medium of claim 8, wherein said communication network is a Voice over Internet Protocol (VoIP) network.

10. The computer-readable medium of claim 8, wherein said at least one network element comprises at least one of: a call control element (CCE), a border element (BE), or an application server (AS).

11. The computer-readable medium of claim 8, wherein said comparing is performed by a network management system (NMS).

12. The computer-readable medium of claim 8, wherein said predefined period of time is determined based on at least one previous service disrupting event.

13. The computer-readable medium of claim 8, wherein a length of said predefined period of time is a configurable parameter.

14. The computer-readable medium of claim 8, wherein said raising comprising:
sending said alarm to a network operator of said communication network if said aberration occurs within said predefined period of time.

15. A system for detecting a potential service disrupting event in a communication network, comprising:
means for collecting a current plurality of minor alarms from at least one network element;
means for comparing said current plurality of minor alarms with a historical plurality of minor alarms for a predefined period of time; and
means for raising an alarm if said comparison shows an aberration that is representative of said potential service disrupting event.

16. The system of claim 15, wherein said communication network is a Voice over Internet Protocol (VoIP) network.

17. The system of claim 15, wherein said at least one network element comprises at least one of: a call control element (CCE), a border element (BE), or an application server (AS).

18. The system of claim 15, wherein said comparing is performed by a network management system (NMS).

19. The system of claim 15, wherein said predefined period of time is determined based on at least one previous service disrupting event.

20. The system of claim 15, wherein said raising comprises:
sending said alarm to a network operator of said communication network if said aberration occurs within said predefined period of time.
